(19) United States
(12) Patent Application Publication
(10) Pub. No.: US 2009/0320144 A1
(43) Pub. Date: Dec. 24, 2009

(54) Method and system for transferring protected content

(75) Inventors: Taiyuan Fang, San Diego, CA (US); Uday Kumar Sinha, San Diego, CA (US); Qing Xia, San Diego, CA (US); Feng Zheng, San Diego, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 12/215,102

(22) Filed: Jun. 24, 2008

(51) Int. Cl. G06F 7/04

(52) U.S. Cl. 726/29

(57) ABSTRACT

There is provided a method of transferring a protected content, in which the method comprises receiving from a first player the protected content via a transmission medium calculating usage rights associated with the protected content to confirm receipt from the first player of some or all of the usage rights associated with the protected content making available the protected content for distribution to a second player, and transmitting the protected content to the second player. The method also includes confirming that the first player has relinquished the some or all of the usage rights associated with the protected content prior to transmitting the protected content to the second player. The protected content may comprise a music file, and the some or all of the usage rights may comprise a usage right for a limited number of protected content players, or comprise a usage right for a limited time duration.

### BACKGROUND OF THE INVENTION

1. Field of the Invention

The present invention is generally in the field of DRM (“digital rights management”) systems. More particularly, the present invention relates to transferring content protected by DRM systems.

2. Background Art

The arts and techniques for generating, transmitting, and consuming legally protected content have advanced significantly with the widespread adoption of computers and the Internet. Modern users of protected content have large appetites for protected content of all kinds, including, for example, music, movies, pictures, and other forms of media. Providers of protected content have turned to increasingly sophisticated protection techniques in order to satisfy these appetites while ensuring that their rights and interests in the protected content are secured.

Techniques for protecting content include DRM techniques such as, for example, limitations on how many times an instance of protected content can be consumed (e.g., viewed or listened to), how many unique users may consume an instance of protected content, or how many copies of an instance of protected content may be made. By providing users with these or similar associated usage rights, different classes of users, and more users overall, can be satisfied. In conventional solutions for avoiding user dissatisfaction with a given combination of protected content and associated usage rights, a user has a variety of other combinations to select. Unfortunately, even given these advances, users of protected content can still be dissatisfied with the rights provided, or with the protected content the users have been provided rights to. For instance, a user who has acquired protected content in the form of a song may listen to the song and tire of it, but may still possess unexercised associated usage rights to the song.

Thus, there is a need in the art for solutions that can facilitate the transfer of protected content to further enhance and develop the market for protected content.

### SUMMARY OF THE INVENTION

There are provided methods and systems for transferring protected content, substantially as shown in and/or described in connection with at least one of the figures, and as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for transferring protected content, according to one embodiment of the present invention;

FIG. 2 is a flowchart presenting a method for transferring protected content, according to one embodiment of the present invention; and

FIG. 3 shows a diagram of an exemplary system for transferring protected content, according to one embodiment of the present invention.

### DETAILED DESCRIPTION OF THE INVENTION

The present invention is directed to a method and system for transferring protected content. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

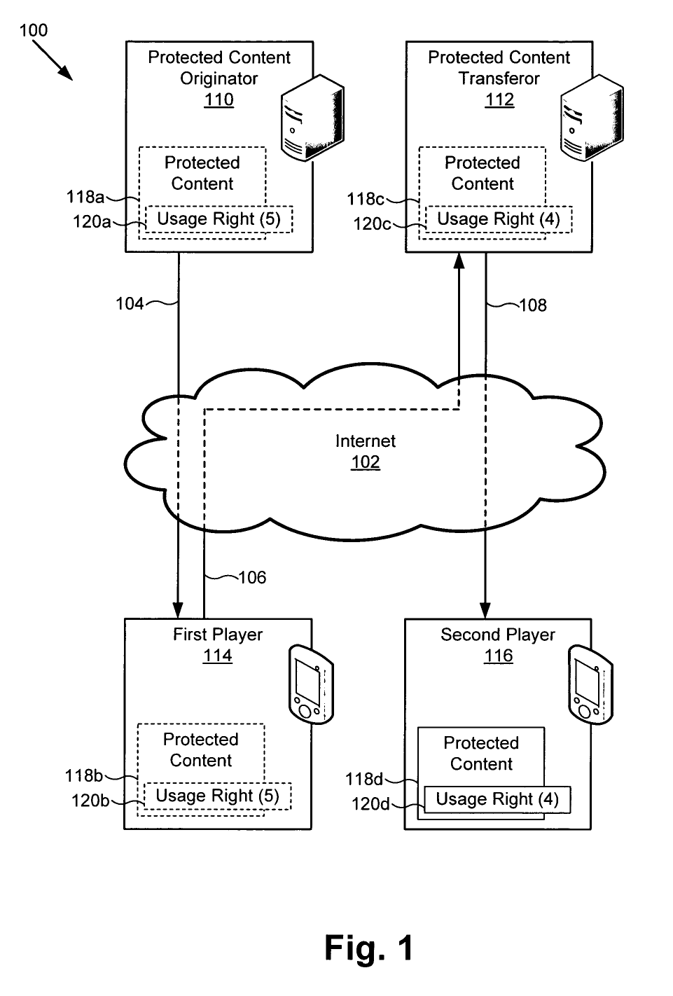

FIG. 1 shows exemplary system 100 for transferring protected content, according to one embodiment of the present invention. System 100 comprises Internet 102, protected content originator 110, protected content transferor 112, first player 114, and second player 116. System 100 additionally comprises protected contents 118a, 118b, 118c, and 118d (“protected contents 118a through 118d”), as well as associated usage rights 120a, 120b, 120c, and 120d (“usage rights 120a through 120d”). Protected contents 118a through 118d and associated usage rights 120a through 120d are transferred via Internet 102 in transactions 104, 106, and 108.

In this embodiment of the present invention, protected content originator 110 is implemented as a server computer comprising a processor, a memory, and an interface configured for communicating with first player 114. Protected content transferor 112 is similarly implemented as a server computer comprising a processor, a memory, and an s interface configured for communicating with first player 114 as well as second player 116. While protected content originator and transferor 110 and 112 are implemented as two separate server computers, in other embodiments protected content originator and transferor 110 and 112 could be implemented as, for example, a single server computer.

First and second players 114 and 116 are portable, networkable music players in this embodiment of the present invention. In other embodiments, first and second players 114 and 116 could be players for another type of content, such as, for example, picture or movie content. Additionally, in other embodiments, first and second players 114 and 116 could be non-portable players, such as, for example, desktop personal computers configured to play music, or DVR (“Digital Video Recording”) set-top boxes configured to play movies. Furthermore, in still other embodiments of the present invention, first and second players 114 and 116 may be configured such that, for example, transactions 104, 106, and 108 do not occur entirely via Internet 102, but instead occur partially or entirely via transfer of a medium such as a writeable CD or DVD.

Protected content 118a in this embodiment of the present invention is a digital music file, such as, for example, an .mp3 file. Protected content 118a is transferred via Internet 102 from protected content originator 110 through first player 114 and protected content transferor 112 to second player 116 (shown finally as protected content 118d) during transactions 104, 106, and 108. Transactions 104, 106, and 108 are lossless with respect to protected content 118a, such that copies of protected content 118a (i.e., protected contents 118b, 118c, and 118d) are bitwise identical copies of protected content 118a.

Usage rights 120a in this embodiment of the present invention is a digital file implementing rights in protected content 118a by, for example, implementing a DRM (“Digital Rights Management”) scheme controlling access to protected content 118a. Usage rights 120a is transferred along with protected content 118a via Internet 102 from protected content originator 110 through first player 114 and protected content transferor 112 to second player 116 (shown finally as usage rights 120d) during transactions 104, 106, and 108. While transactions 104, 106, and 108 are lossless with respect to usage rights 120a through 120d, intervening devices may alter a copy of usage rights 120a. For example, usage rights 120d is a bitwise identical copy of usage rights 120c, but first player 114 alters usage rights 120b after utilization of protected content 118b, as described below, such that usage rights 120b is not a bitwise identical copy of usage rights 120a.

In this embodiment of the present invention, usage rights 120a controls access to protected content 118a by implementing a DRM scheme limiting the number of times protected content 118a, an .mp3 file, may be listened to. In particular, usage rights 120a limits access to protected content 118a such that protected content 118a may be listened to, for example, only 5 times. In other embodiments, usage rights 120a may instead, for example, limit the number of users who may listen to protected content 118a, or set a calendar date and time after which protected content 118a may not be listened to. Because both protected content 118a and usage rights 120a are digital files, i.e. data, in this embodiment of the present invention, participating devices must be designed to honor the restrictions of usage rights 120a, e.g. first and second players 114 and 116 must be DRM-compliant devices. Otherwise, restrictions in usage rights 120a might not be observed.

During transaction 104, in one embodiment of the invention protected content 118a and associated usage rights 120a are transferred from protected content originator 110 to first player 114 via Internet 102. After transaction 104, protected content originator 110 deletes protected content 118a and associated usage rights 120a, and may make a record of transaction 104. Also, copied protected content 118b and associated usage rights 120b exist on first player 114. A user of first player 114 may thus utilize, e.g. listen to, protected content 118b 5 times, according to the restrictions of usage rights 120b. After utilizing protected content 118b, first player 114 may modify usage rights 120b by decrementing the remaining times a user may listen by 1. Usage rights 120b thus embodies a right to listen to protected content 118b diminished by a count, i.e. a right to listen 4 times. If the user of first player 114 does not enjoy listening to protected content 118b, the user may take the novel step of selling the remaining rights in protected content 118b to protected content transferor 112. In particular, if the user of first player 114 listens to protected content 118b 1 time, he may sell the right to listen to protected content 118b up to 4 more times. In contrast, in a conventional system for transferring protected content, a user may have no such recourse to the invention's protected content transferor 112 after transaction 104.

During transaction 106, in one embodiment protected content 118b and associated usage rights 120b are transferred from first player 114 to protected content transferor 112 via Internet 102. After transaction 106, first player 114 may delete protected content 118b and associated usage rights 120b, if the user of first player 114 has transferred all rights to listen to protected content 118b, or may modify associated usage rights 120b, if the user of first player 114 has transferred only some rights to listen to protected content 118b.

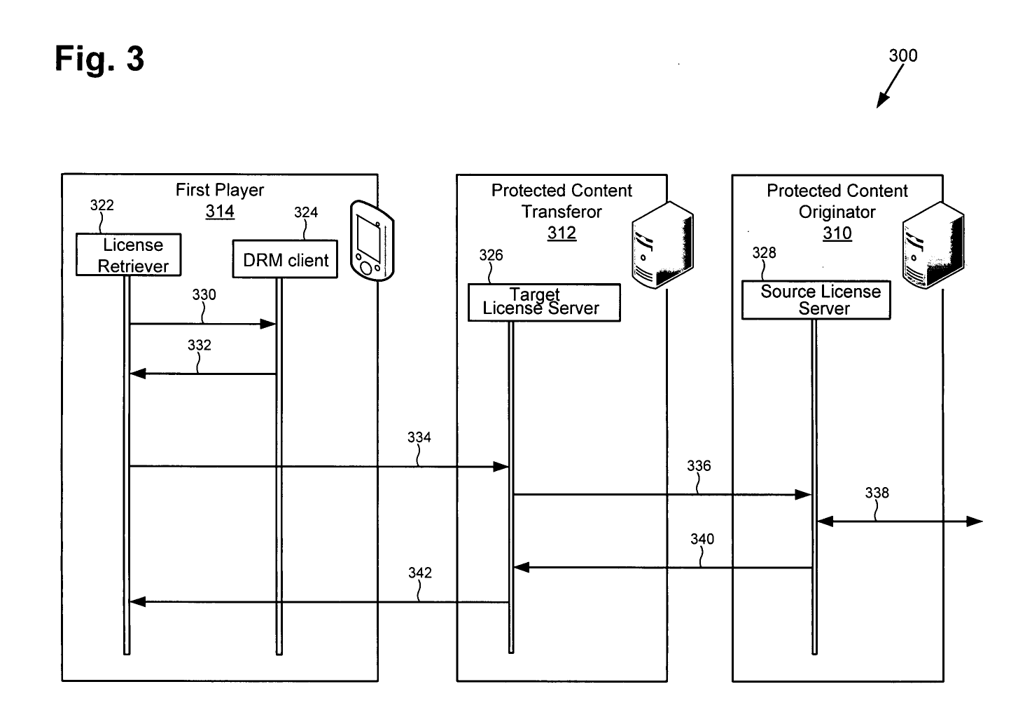

Thus, copied protected content 118c and associated usage rights 120c exist on protected content transferor 112. Protected content transferor 112 concludes transaction 106 by calculating usage rights 120c received from first player 114 to confirm proper receipt of usage rights 120c, i.e. to confirm that first player 114 did not transfer more rights than existed in usage rights 120b prior to transaction 106. Protected content transferor 112 may also confirm that first player 114 has deleted protected content 118b and associated usage rights 120b, or properly modified associated usage rights 120b, to confirm that first player 114 has not retained more rights than entitled after transaction 106. Several substeps of transaction 106 are shown in FIG. 3 and discussed in greater detail below.

After confirming the conditions above, after transaction 106 protected content transferor 112 makes protected content 118c and associated usage rights 120c available for distribution. In the present embodiment, protected content transferor 112 does so by listing protected content 118c for sale on a web site on Internet 102, for example, while in other embodiments protected content transferor 112 may utilize other advertisement methods. If a user, such as a user of second player 116, wishes to acquire protected content 118c, the user may request protected content 118c and begin transaction 108.

During transaction 108, in one embodiment protected content 118c and associated usage rights 120c are transferred from protected content transferor 112 to second player 116 via Internet 102. After transaction 108, protected content transferor 112 deletes protected content 118c and associated usage rights 120c, and copied protected content 118d and associated usage rights 120d exist on second player 116. In the present example, a user of second player 116 may thus listen to protected content 118d 4 times, and thereby exercise the rights in protected content 118d relinquished earlier by the user of first player 114 during transaction 106.

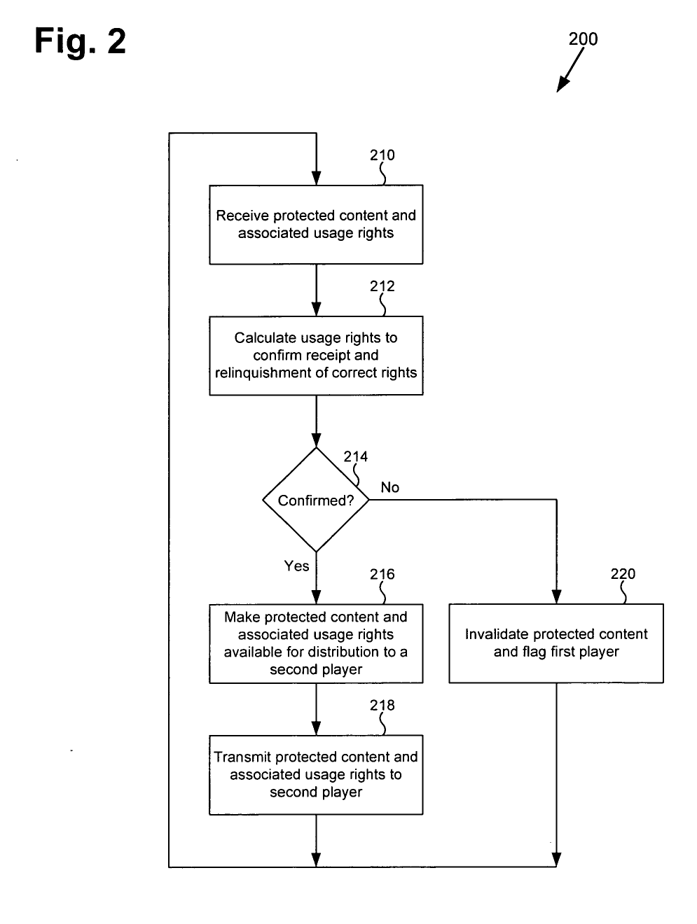

FIG. 2 shows flowchart 200 of an exemplary method for transferring protected content, according to one embodiment of the present invention. Certain details and features have been left out of flowchart 200 that are apparent to a person of ordinary skill in the art. For example, a step may comprise one or more substeps or may involve specialized equipment or materials, as known in the art. While steps 210 through 220 indicated in flowchart 200 are sufficient to describe one embodiment of the present invention, other embodiments of the invention may utilize steps different from those shown in flowchart 200.

In step 210 of flowchart 200, a protected content transferor, for example protected content transferor 112 in FIG. 1, receives from a first player, such as first player 114, a protected content, such as protected content 118b. The protected content transferor may receive the protected content via the Internet, as depicted in FIG. 1, or via another transfer method, such as via a direct data connection or via a physical medium, i.e. a CD, DVD, or cassette. The protected content received by the protected content transferor is accompanied by an associated usage right, such as usage rights 120b. In various embodiments, the protected content transferor may receive the associated usage right before, during, or after receiving the protected content. The usage right may be in a separate file from the protected content. For example, the protected content can be an .mp3 music file and the usage right can be a separate encrypted data file. Alternatively, the usage right can be in the same file as the protected content, in a header or footer section or interspersed throughout the protected content. In this embodiment, after receiving the protected content, the protected content transferor stores the protected content as a digital file.

In step 212 of flowchart 200, the protected content transferor calculates the usage rights associated with the protected content to confirm receipt from the first player of some or all of the usage rights, and to confirm that the first player has relinquished the same usage rights. For example, the first player may have usage rights in the protected content to listen to the protected content 4 times, and may transfer usage rights in the protected content to listen to the protected content 3 times. The first player will then retain a usage right in the protected content to listen to the protected content 1 time, and the protected content transferor will have usage rights in the protected content to listen to the protected content 3 times. However, in another example, the first player may have usage rights in the protected content to listen to the protected content 4 times, but may attempt to transfer usage rights in the protected content to listen to the protected content 5 times. In this circumstance, the protected content transferor cannot confirm receipt of some or all of the usage rights in the protected content, because the first player has attempted to transfer more than all of the usage rights.

In step 214 of flowchart 200, the protected content transferor proceeds to either step 216 or step 218. The protected content transferor proceeds to step 216 if the first player transferred some or all of the usage rights associated with the protected content and relinquished the same some or all of the usage rights transferred. If the protected content transferor cannot confirm these conditions, i.e., if the first player has transferred usage rights improperly, or is retaining usage rights improperly, then the protected content transferor proceeds to step 220.

If the protected content transferor proceeds to step 220, then the first player has transferred usage rights improperly or is retaining usage rights improperly. In this embodiment of the present invention, the protected content transferor reacts in step 220 by invalidating the protected content received and by flagging the first player as an unreliable player. The protected content received can be invalidated via, for example, deletion, and the first player can be flagged as an unreliable player by, for example, recording the IP (“Internet Protocol”) address utilized by the first player, by recording a hardware identifying address of the first player, or by making a notation in an account of the first player. In other embodiments of the invention, instead of invalidating the protected content and flagging the first player, the protected content transferor may instead attempt to reconcile the improper transfer or retention of usage rights, or may reject or ignore the improper transfer. After completing step 220, the protected content transferor returns to step 210 and awaits receipt of additional protected content.

If the protected content transferor proceeds to step 216 after step 214 instead of step 220, then the first player has transferred and retained usage rights properly. The protected content transferor thus proceeds to make the protected content available for distribution to a second player. The protected content transferor does so, in the present embodiment, by listing the protected content and associated usage rights on an Internet web site accessible by one or more second players. In other embodiments of the present invention the protected content transferor may use other methods to make the protected content available to a second player.

In step 218 of flowchart 200, a second player has requested the protected content and associated usage rights, and the protected content transferor proceeds to transmit the protected content to the second player. In this embodiment, the protected content is read from a memory of the protected content transferor and transmitted to the second player via the Internet, while in other embodiments the protected content may be transmitted via another transfer method, such as via a direct data connection or via a physical medium, i.e. a CD, DVD, or cassette.

FIG. 3 shows exemplary system 300 for performing a transaction corresponding to transaction 106 of FIG. 1, according to one embodiment of the present invention. System 300 comprises protected content originator 310, protected content transferor 312, and first player 314, which correspond respectively to protected content originator 110, protected content transferor 112, and first player 114 in system 100. System 300 performs substeps 330, 332, 334, 336, 338, 340, and 342 (“substeps 330 through 342”), which in one embodiment together correspond to transaction 106 in system 100. Notably, substeps 330 through 342 include substep 336 and substep 340 between protected content transferor 312 and protected content originator 310 not shown in corresponding transaction 106. Protected content transferor 312 comprises target license server 326, protected content originator 310 comprises source license server 328, and first player 314 comprises license retriever 322 and digital rights management (“DRM”) client 324. In one embodiment, target and source license servers 326 and 328 are software processes executing on protected content transferor and originator 312 and 310, and license retriever 322 and DRM client 324 are software processes executing on first player 314.

In substep 330, license retriever 322 sends a retrieve license rights object message to DRM client 324. The retrieve license rights object message requests information from DRM client 324 about, for example, a usage right corresponding to usage right 120b in FIG. 1. In one embodiment, the retrieve license rights object message of substep 330 includes information such as a client device identification, a content header object, a license key, and residual rights information. DRM client 324 responds in substep 332 with a no license message or with a retrieved license challenge object message. For example, a retrieved license challenge object message may contain information about the usage right corresponding to usage right 120b.

Subsequently, in substep 334, license retriever 322 sends a license surrender object message to target license server 326 of protected content transferor 312, requesting a retrieved license challenge object. While the messages of substeps 330 and 332, described above, are sent, for example, between software processes on first player 314, the message of substep 334 (and the messages of substeps 336, 340, and 342, described further below) is sent utilizing, for example, the Internet. After target license server 326 receives the message of substep 334, target license server 326 may send a subsequent message in substep 336 to source license server 328 of protected content originator 310 for coordination or requesting a license key object. After optionally interacting with a content provider (not shown) in substep 338, source license server 328 responds to target license server 326 with a message in substep 340 containing a license transfer response object message.

Subsequently, in substep 342, target license server 326 of protected content transferor 312 responds to license retriever 322 of first player 314 with a license surrender response object message. The license surrender response object message may include, for example, a uniform resource locator (“URL”) for a license server such as, for example, target or source license server 326 or 328. After substep 342, license retriever 322 of first player 314 may update a content file with the URL and other information, if any, in the license surrender response object message. Substep 342, the last of substeps 330 through 342, thus in one embodiment of the invention concludes a transaction corresponding to transaction 106 in system 100.

In the manner described above, the invention as shown in exemplary system 100, exemplary flowchart 200, and exemplary system 300 provides solutions that can facilitate the transfer of protected content to further enhance and develop the market for protected content, where such solutions enable the transfer protected content and some or all associated usage rights. A user of protected content, after fulfilling his personal usage of the protected content, no longer has to retain the protected content and leave some associated usage rights unexercised. Instead, by utilizing the present invention, the user can resell the protected content and associated usage rights, thereby enabling another user to subsequently enjoy the protected content at a reduced price.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method of transferring a protected content, the method comprising:
receiving from a first player the protected content via a transmission medium;
calculating usage rights associated with the protected content to confirm receipt from the first player of some or all of the usage rights associated with the protected content;
making available the protected content for distribution to a second player; and
transmitting the protected content to the second player.

2. The method of claim 1, further comprising confirming that the first player has relinquished the some or all of the usage rights associated with the protected content prior to transmitting the protected content to the second player.

3. The method of claim 1, wherein the protected content comprises a music file.

4. The method of claim 1, wherein the some or all of the usage rights comprise a usage right for a limited number of protected content players.

5. The method of claim 1, wherein the some or all of the usage rights comprise a usage right for a limited time duration.

6. The method of claim 1, wherein the some or all of the usage rights comprise a usage right for a limited number of unique uses.

7. The method of claim 1, wherein the transmission medium comprises a digital transmission network.

8. The method of claim 1, wherein the transmission medium comprises the Internet.

9. The method of claim 1, wherein the receiving comprises receiving and storing a digital file.

10. The method of claim 1, wherein the transmitting comprises reading and transmitting a digital file.

11. A system for transferring a protected content, the system comprising:
an interface configured to communicate with a first player and a second player via a transmission medium;
a memory configured to store the protected content and usage rights associated with the protected content; and
a processor configured to receive via the interface the protected content from the first player, the processor further configured to calculate the usage rights associated with the protected content to confirm receipt from the first player of some or all of the usage rights associated with the protected content, the processor further configured to make available the protected content for distribution to the second player, the processor further configured to transmit via the interface the protected content to the second player.

12. The system of claim 11, the processor further configured to confirm that the first player has relinquished the some or all of the usage rights associated with the protected content prior to transmitting the protected content to the second player.

13. The system of claim 11, wherein the protected content comprises a music file.

14. The system of claim 11, wherein the some or all of the usage rights comprise a usage right for a limited number of protected content players.

15. The system of claim 11, wherein the some or all of the usage rights comprise a usage right for a limited time duration.

16. The system of claim 11, wherein the some or all of the usage rights comprise a usage right for a limited number of unique uses.

17. The system of claim 11, wherein the transmission medium comprises a digital transmission network.

18. The system of claim 11, wherein the transmission medium comprises the Internet.

19. The system of claim 11, wherein the receiving comprises receiving and storing a digital file.

20. The system of claim 11, wherein the transmitting comprises reading and transmitting a digital file.
